(19) United States
(12) Patent Application Publication
(10) Pub. No.: US 2002/0159371 A1
(43) Pub. Date: Oct. 31, 2002

(54) Loading tray for optical disk drive in upright position

(76) Inventors: Shih-Lin Yeh, Hsinchu (TW); Tsing-Sung Hsu, Hsinchu (TW); Yi-Cheng Tsao, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/841,070

(22) Filed: Apr. 25, 2001

(51) Int. Cl. G11B 33/02

(52) U.S. Cl. 369/75.2

(57) ABSTRACT

A loading tray for optical disk drive in upright position is disclosed. A disk-supporting surface and a disk-contacting surface is designed on the tray as a single component. The disk-supporting surface is an upright slanting surface or a curved surface. Thereby, with the help of the special shape designed on the tray surface, the weight of a disk can be automatically guided to be as a pushing force for mounting the optical disk toward the disk contacting surface so that the disk can be attached tightly on the tray free of dropping out. The loading device can accommodate either thin or thick disk conformed to the Red Book of CD. The utility of the present design make a disk loaded more efficiently and reduce the possibility of scratching or damaging the data surface of the disk.

### FIELD OF THE INVENTION

The present invention relates to a loading tray for optical disk drive in upright position, the loading tray having a simple tongues shape design to support the disk to be free of falling. The special structure on the tray is suitable for supporting disks with different thickness conformed to the Red Book of CD. The supporting tongues are designed as any kind of special surface like slants, curves or higher order spline sections to secure the disk tightly through the gravity weight of disk. By employing the compact tongues design, more space above the tray is available and the possibility of disk damage due to wearing and tearing is also reduced.

### BACKGROUND OF THE INVENTION

The optical storage technology is widely adopted in the computer peripherals, such as CD-ROM, CD-RW, DVD-ROM, and DVD-RAM, etc. Low cost, lightweight and compact size are a trend for designing an optical disk drive in the future.

The installation of an optical disk drive in a personal computer may be mounted in level or upright position for suiting different applications. A tray is a primary device for loading and unloading an optical disk by a user. Therefore, an appropriate carrier for loading the disk is necessary so that the optical disk can be loaded on the tray more reliably. Further information about this concept may refer to U.S. Pat. No. 5,930,218.

The current devices of prior art for loading a disk in upright mounted applications are usually consisted of a tray body with two or three parts. Sometimes, it is necessary to enable it by hand before using the vertical mounting function. Extra manpower is used in such kind of design, and thus increasing the cost and possibility to scratch the disk. Other prior art adopts a single part design of tray for performing the vertical function, but the disk cannot attach tray tightly. The use of space is limited.

As shown in FIG. 1, if the optical disk is installed uprightly, then the gravitation force is along negative X direction. The disk 2 is loaded and unloaded in Y direction. As the disk 2 moves insides the disk drive, it must avoid to contact or impact any inner parts of the drive, such as the turntable of spindle motor, pick up head and clamping device, etc. and to assure that the disk 2 will not be dropped out accidentally.

In the prior art, as shown in FIGS. 2 to 5, a tray 3 supporting a disk 4 is illustrated. Referring to FIG. 4, obviously, the disk 4 will shift outwards from the tray and thus, deviate from an ideal position of a disk 5 as shown in FIG. 5. This is because that the distance between the disk supporting surface 3a and the disk contacting surface 3b is too large. If the disk 4 lies obliquely on the surface of tray 3 as illustrated in FIGS. 6 to 10, then the disk 4 is still away from an ideal position of the disk 5 even though the disk 4 does not turn around outwards. If the distance between the disk supporting surface 3a and the disk contacting surface 3b is reduced as shown in FIGS. 11 to 15, the tolerance for the 4 thickness of the disk 4 should be considered to avoid a thicker disk mounting problem. We conclude that the distance to be reduced is finite. Therefore, the disk 4 is possibly shifted from an ideal position of the disk 5 as illustrated in FIG. 13. As a result, the data surface of the optical disk is possibly scratched or damaged when the disk passes through the disk drive.

Therefore, there is an eager demand for a novel design of the disk carrier device on the tray of an optical disk drive to increase the space efficiency and convenience in application with a lower cost.

### SUMMARY OF THE INVENTION

Therefore, the primary object of the present invention is to provide a loading tray for optical disk drive in upright position, wherein under the condition of without increasing number of parts, when an optical disk on the tray passes through a disk drive in an upright way, the disk can remain to attach to the disk-supporting surface steadily despite of the thickness of a disk. By employing the compact tongues design, more space above the tray is available and the possibility of disk damage due to wearing or tearing is also reduced.

Another object of the present invention is to provide a simple structured upright disk carrier of the tray of an optic disk drive. Through the special shape of the disk-supporting surface of the tray, the disk can be self guided by gravitation force to resist against the disk-supporting surface.

The various objects and advantages of the present invention will be more briefly acknowledged by the following detailed description when it is read in conjunction with the appended drawing.

### BRIEF DESCRIPTION OF THE DRAWINGS

FIG. 1 is a perspective view of a prior art optical disk.

FIG. 2 is a lateral view of a prior art of a vertical tray carrier of an optical disk drive.

FIG. 3 is a cross section view along line A-A of FIG. 2.

FIG. 4 is a cross section view along line B-B of FIG. 2.

FIG. 5 is an enlarged details of the part A in FIG. 4.

FIG. 6 shows a top view of a prior art with another different loading status 1.

FIG. 7 is a cross section view along line A-A of FIG. 6.

FIG. 8 is a cross section view along line B-B of FIG. 6.

FIG. 9 is an enlarged detail of part A of FIG. 8.

FIG. 10 is an enlarged detail of part B of FIG. 8.

FIG. 11 shows a lateral view of a prior art with another different loading status 2.

FIG. 12 is a cross section view along line A-A of FIG. 11.

FIG. 13 is a cross section view along line B-B of FIG. 11.

FIG. 14 is an enlarged details of the part A in FIG. 13.

FIG. 15 is an enlarged detail of the part B in FIG. 13.

FIG. 16 is a lateral view of the present invention when loading a thin disk.

FIG. 17 is a cross section view along line A-A of FIG. 16.

FIG. 18 is a cross section view of line B-B of FIG. 16.

FIG. 19 is an enlarged details of the part A in FIG. 18.

FIG. 20 is an enlarged detail of the part B in FIG. 17.

FIG. 21 is a lateral view of the present invention when loading a thick disk.

FIG. 22 is a cross section view along line A-A of FIG. 21.

FIG. 23 is a cross section view of line B-B of FIG. 21.

FIG. 24 is an enlarged details of the part A in FIG. 23.

FIG. 25 is an enlarged detail of the part B in FIG. 22.

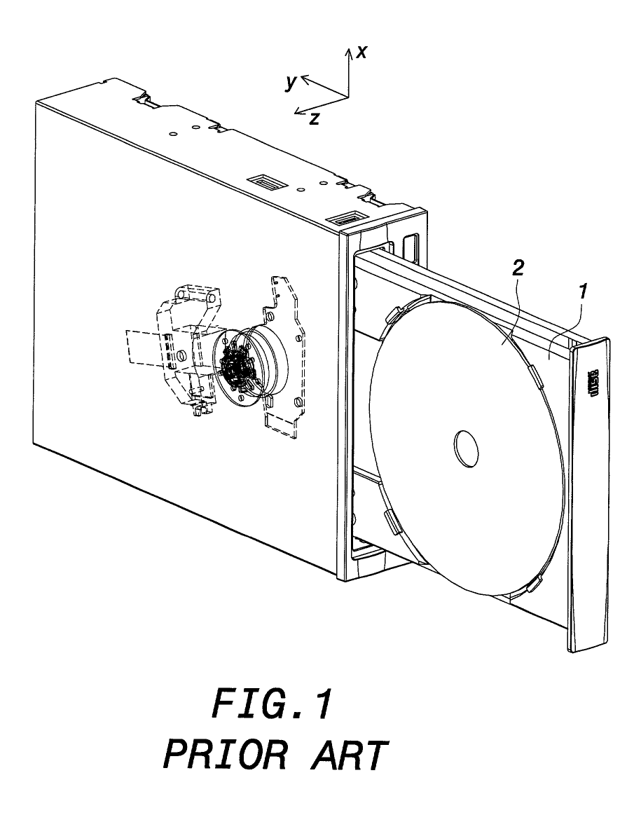

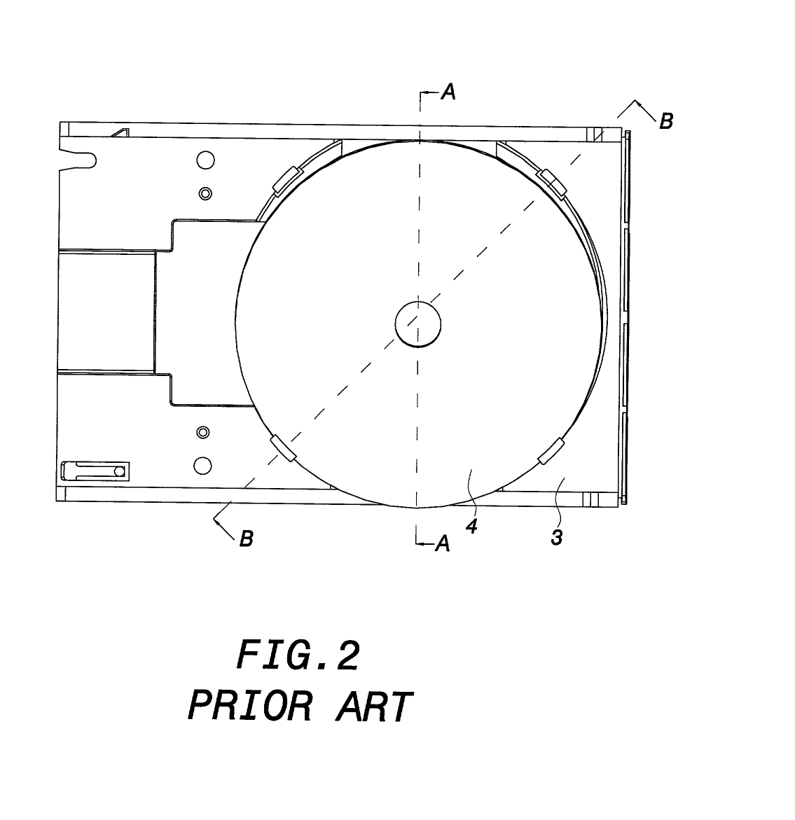

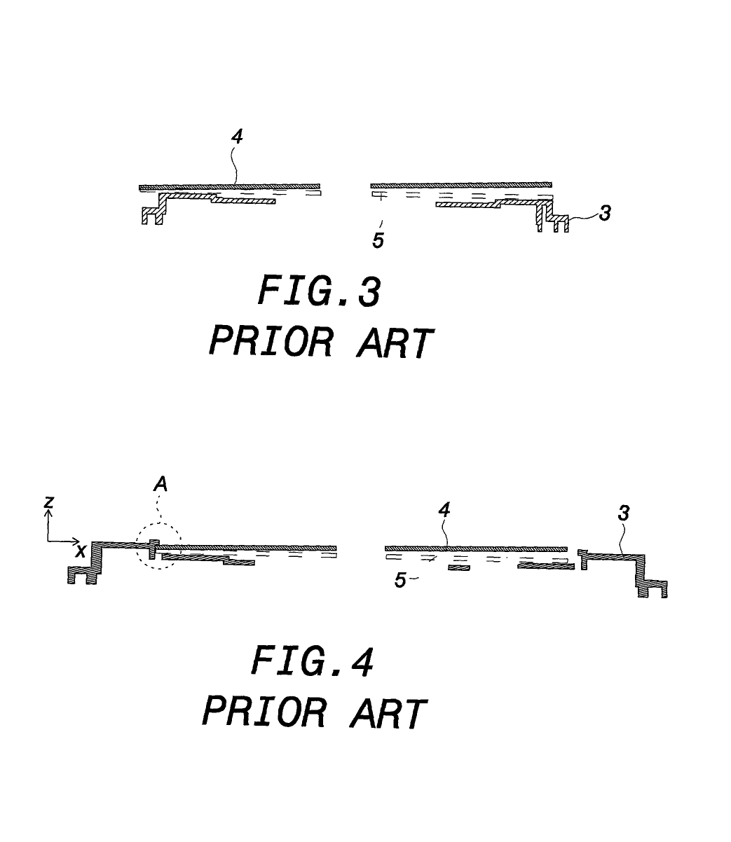

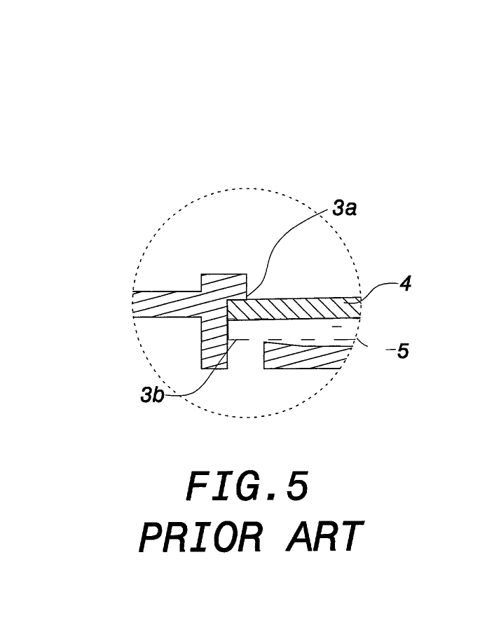

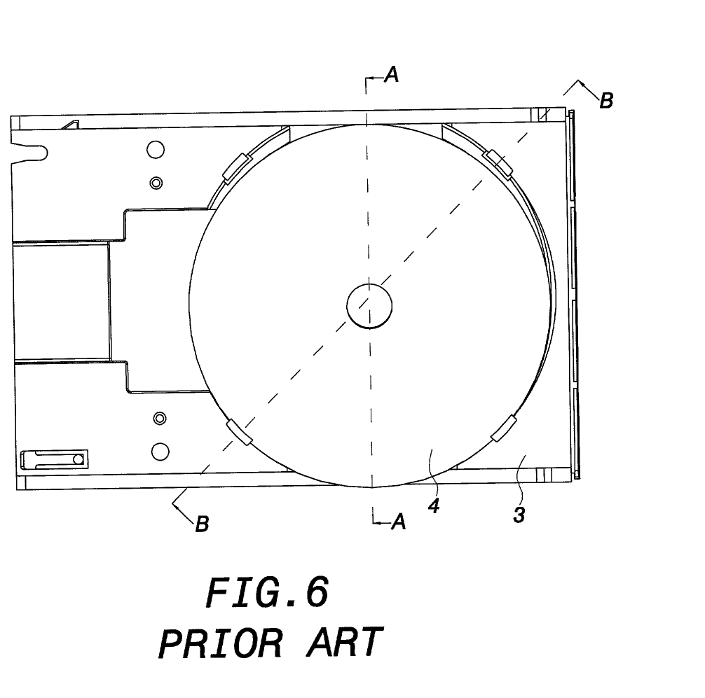

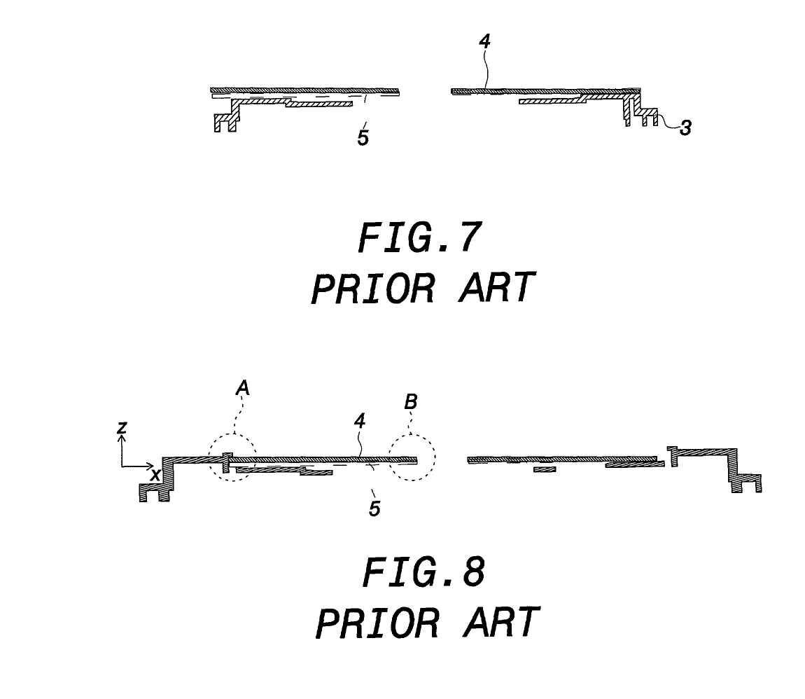

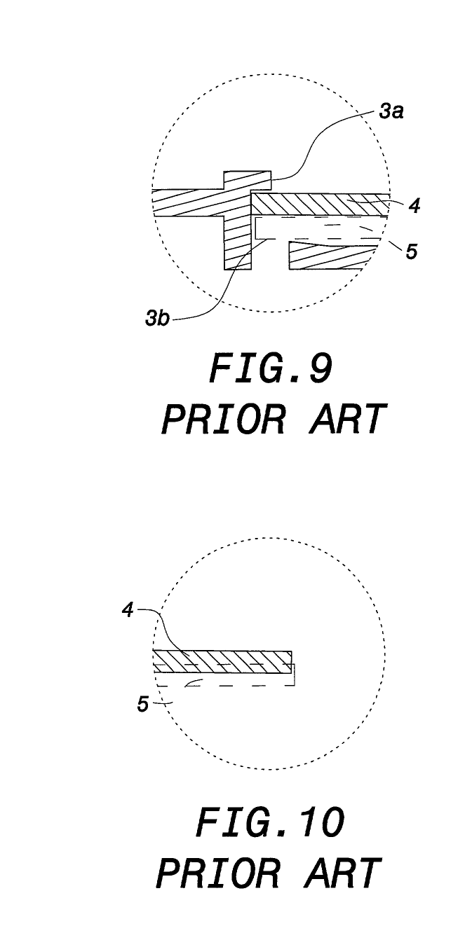

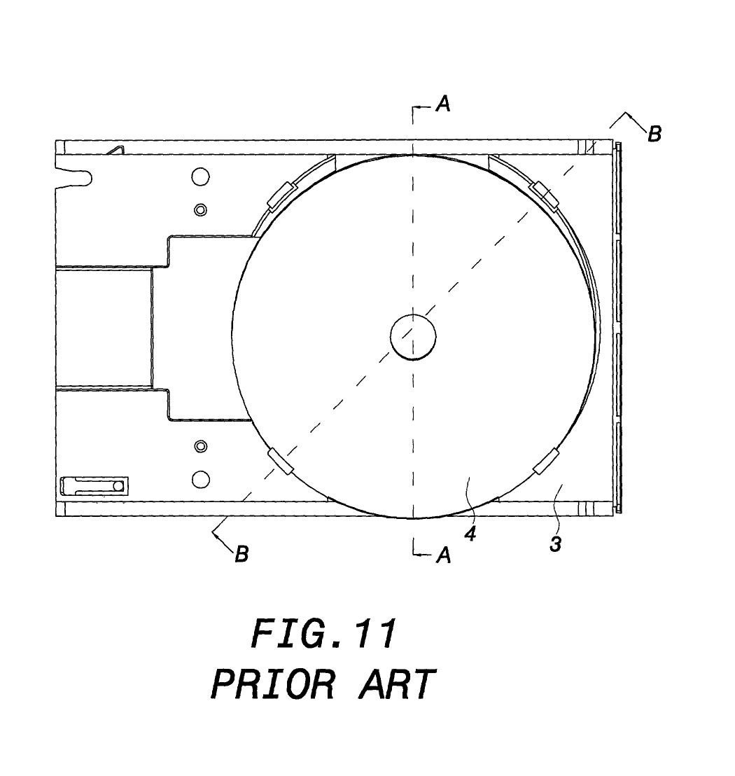

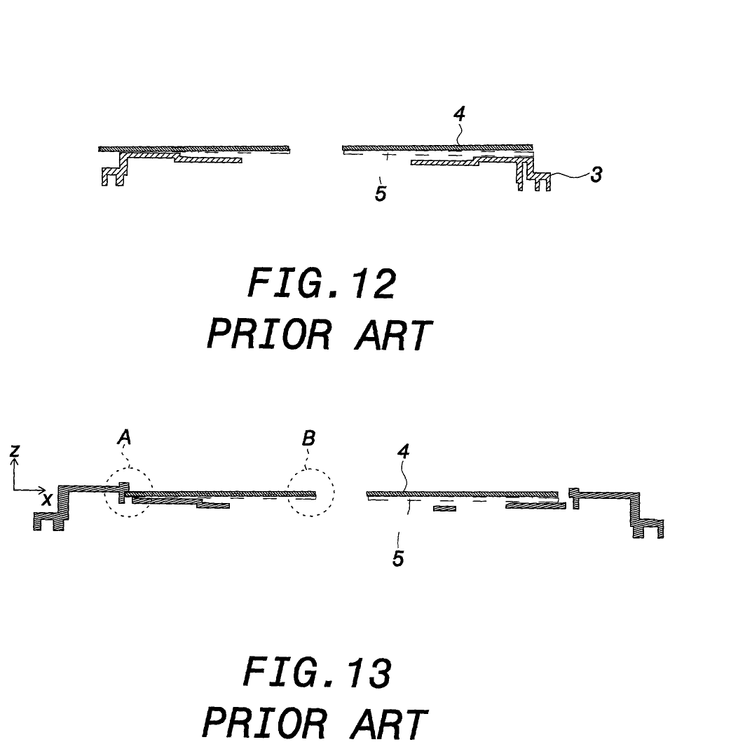

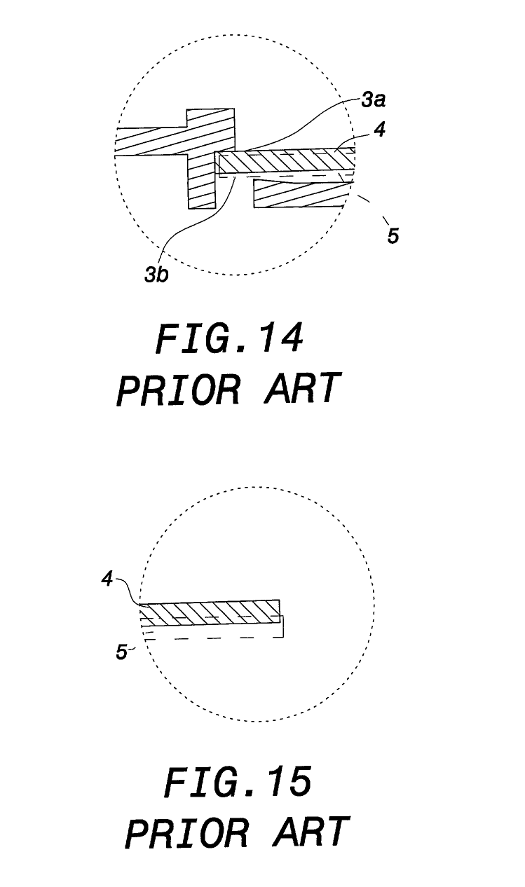

### DETAILED DESCRIPTION OF THE PREFERRED EMBODIMENTS

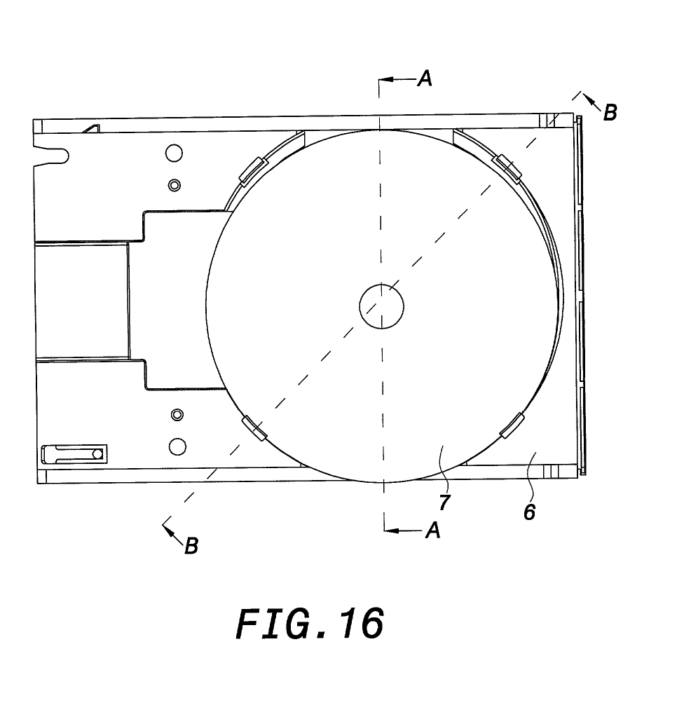

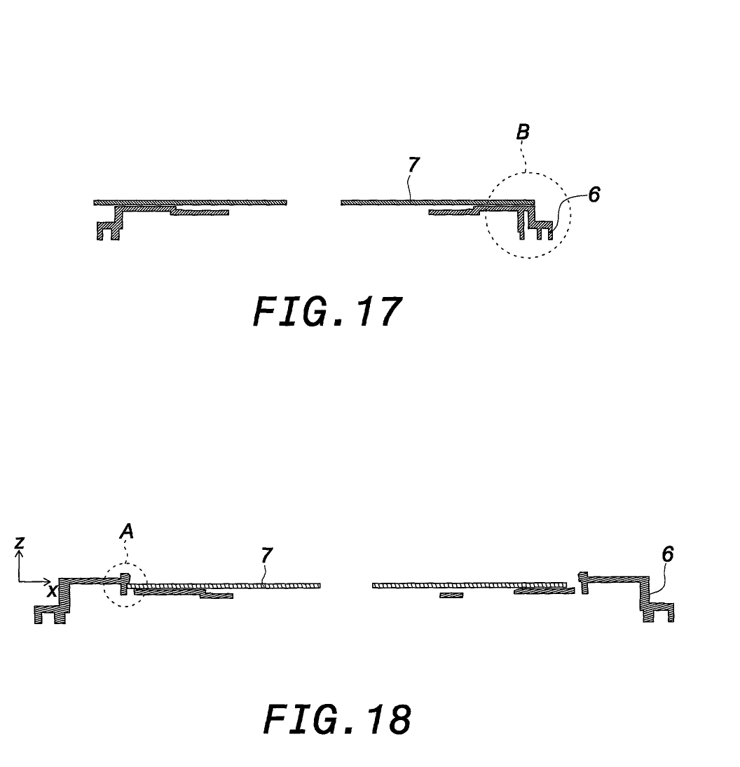

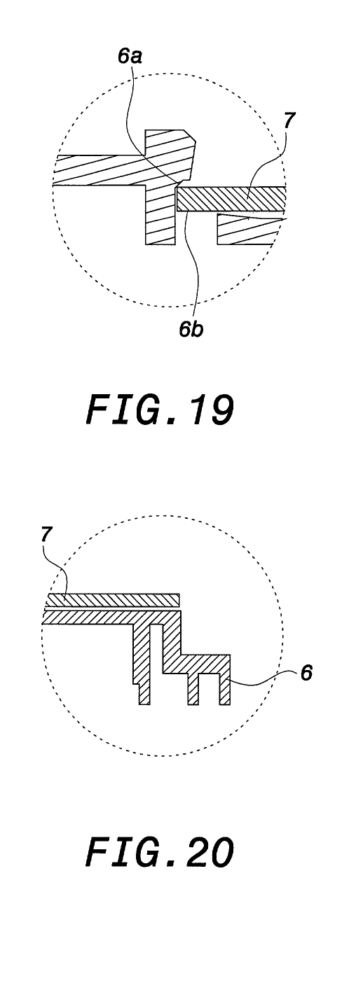

With reference to FIGS. 16, 17, 18, 19 and 20, a loading tray for optical disk drive in upright position according to a preferred embodiment of the present invention is illustrated. The tray 6 of the present invention is installed with a disk supporting surface 6a and a disk contacting surface 6b. In the present invention, the disk supporting surface 6a on the tray 6 is improved. The disk supporting surface 6a of prior art is usually a straight slope surface, but in the present invention, the disk supporting surface 6a may be designed as different shapes, such as a curve or a higher order spline or other surfaces with an equivalent guiding effect. The length of the supporting surface 6a of the tray 6 supporting the circumference of the disk 7 is not confined. In the drawing, the direction of the gravitation force is negative X direction. Since the shape of the disk supporting surface 6a will cause the gravitation force of the disk 7 to be guided to generate a force in negative Z direction. This force will cause the disk 7 to be pushed toward the disk contacting surface 6b of the tray 6. As a result, the disk 7 can be attached tightly on the tray 6. FIG. 19 shows the action of a thinner disk 7 to a slanting surface (disk supporting surface 6a). FIG. 18 shows an ideal position that the thinner disk 7 attached tightly on the tray 6. The thinner disk 7 does not move away from the tray 6.

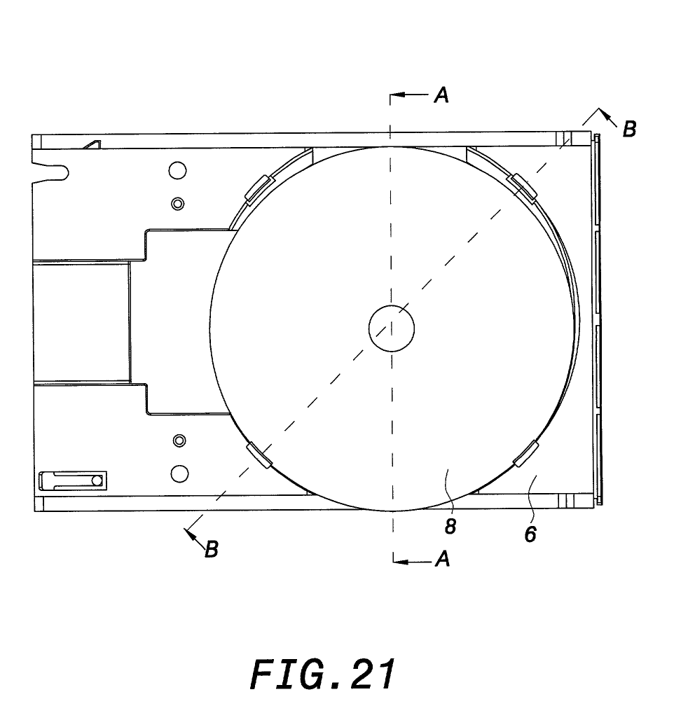

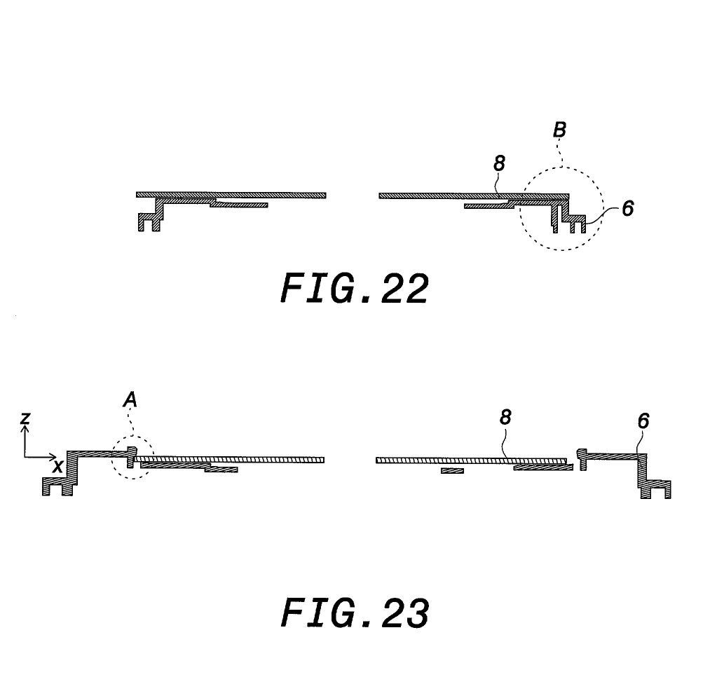

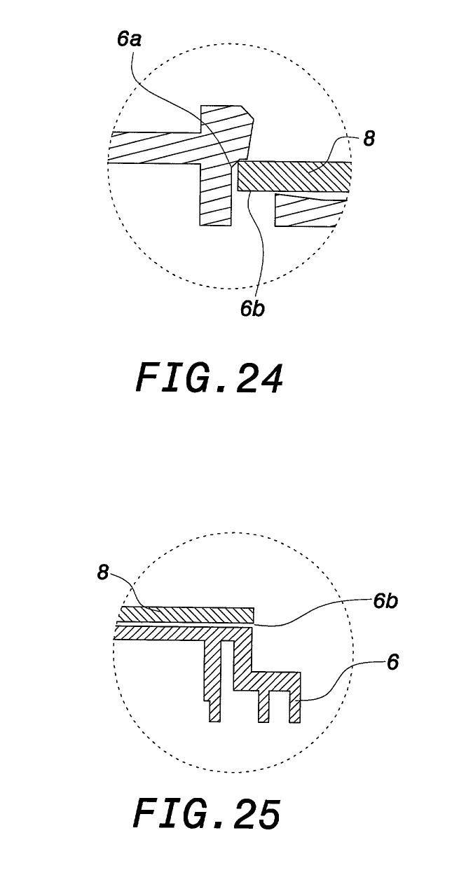

As shown in FIGS. 21 to 25, a thinner disk 7 resists against the tray 6 and the disk supporting surface 6a. Similarly, the gravitation force of the tray 6 is guided by the disk supporting surface 6a so that the thicker disk 8 tightly resists against the disk contacting surface 6b. Referring to FIG. 23, the thicker disk 8 has the same effect as that on the tray 6 and does not move away from the tray 6. Therefore, despite of the disk thickness of disk, it can be placed in an ideal position. The utility of the present design make a disk loaded more efficiently and reduce the possibility of scratching or damaging the data surface of the disk.

In the present invention, through the design about the special shape design of the disk-supporting surface on the tray, the disk can be guided by gravitation force pro se to resist against the disk-supporting surface. Furthermore, any standard disk with different thickness can be employed in the present invention. Therefore, in the present invention, under the condition of part number reduction, as an optical disk on the tray passes through the drive in an upright mounting application, the disk remains to adhere to the disk supporting surface steadily. Furthermore, the present invention is especially beneficial to a double-sides optical disk like DVD media.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A loading tray for optical disk drive in upright position, the loading tray having a disk-supporting surface installed thereon and a disk-contacting surface being designed on the tray as a single part;
the shape of disk-supporting surface being selected from one of a group containing a curved surface or a spline surface;
when a disk is loaded, the weight of the optical disk is guided to be as a pushing force for mounting the optical disk toward the disk contacting surface.
